(19) United States
(12) Patent Application Publication
(10) Pub. No.: US 2007/0145624 A1
(43) Pub. Date: Jun. 28, 2007

(54) MOLD AND METHOD FOR MANUFACTURE OF MOLDED ELEMENT

(75) Inventor: JEFFREY WEBB, Bolingbrook, IL (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: WOODBRIDGE FOAM CORPORATION, Mississauga (CA)

(21) Appl. No.: 11/554,695

(22) Filed: Oct. 31, 2006

Related U.S. Application Data
(60) Provisional application No. 60/731,262, filed on Oct. 31, 2005.

(51) Int. Cl. B29C 44/12; B29C 33/00

(52) U.S. Cl. 264/46.4; 425/DIG. 60; 425/182

(57) ABSTRACT

Mold and method for manufacture of a molded element includes structure and/or process by which a fastener assembly is placed in an area of a mold element. After a liquid foamable composition is didpensed into the mold, a valve element is actuated at a prescribed pressure to remove gas from the mechanical fastener area so that the liquid foamable composition can fill substantially the mold cavity to produce the molded element.

### CROSS-REFERENCE TO RELATED APPLICATION

This application claims the benefit of U.S. Provisional Application No. 60/731,262, filed Oct. 31, 2005, incorporated herein by reference.

### BACKGROUND OF THE INVENTION

1. Field of the Invention

In one of its aspects, the present invention relates to a method for production of a molded cushion element. In another of its aspects, the present invention relates to mold for production of a cushion element

2. Related Art

In the art of adhering cover materials to cushion elements, it is known to utilize a mechanical fastener assembly to adhere a cover material to a cushion element.

One particular class of cushion elements comprises isocyanate-based polymer foams. Isocyanate-based polymer foams are known in the art. Generally, those of skill in the art understand isocyanate-based polymer foams to be polyurethane foams, polyurea foams, polyisocyanurate foams and mixtures thereof.

It is also known in the art to produce isocyanate-based polymer foams by a variety of techniques. Indeed, one of the advantages of isocyanate-based polymers compared to other polymer systems is that polymerization and foaming can occur in situ. This results in the ability to mold the polymer while it is forming and expanding.

One of the conventional ways to produce an isocyanate-based polymer foam, such as a polyurethane foam, is known as the “one-shot” technique. In this technique, the isocyanate, a suitable polyol, a catalyst, water (which acts as a reactive blowing agent and can optionally be supplemented with one or more blowing agents) and other additives are mixed together at once in a suitable mixer to produce a liquid foamable composition. The liquid foamable composition and is then expanded and/or molded to produce polyurethane foam. Generally, if one were to produce a polyurea, the polyol would be replaced with a suitable polyamine. A polyisocyanurate may result from cyclotrimerization of the isocyanate component. Urethane-modified polyurea foam or polyisocyanurate foam are known in the art. In either scenario, the reactants would be intimately mixed very quickly using a suitable mixer.

When it is desired to utilize a mechanical fastener to adhere a cover material to the isocyanate-based polymer foam, it is known to place the mechanical fastener in the mold such that it is molded into the finished foam product. Generally, a conventional mechanical fastener comprises a touch fastening surface. As used throughout this specification, the term “touch fastening surface” is intended to mean a surface which will adhere to a complementary surface on the cover material to be adhered to the cushion element. Practically, the touch fastening surface has taken the form of one half of a “hook and loop” fastener system. In other words the touch fastening surface comprises a plurality of hook elements and the cover material comprises a plurality of loop elements, or vice versa, such that the hook elements and loop elements mechanically engage one another when pressed into contact. Generally, it has been preferred to have the hook elements on the mechanical fastener molded in the cushion element and the loop elements on the cover material to be adhered to the cushion element.

Conventionally, the mechanical fastener is placed in the mold such that the touch fastening surface is flush against a surface of the mold (usually the mold surface is provided with a trench for receiving the touch fastening surface of the mechanical fastener)—i.e., such that a touch fastening surface is exposed in the finished foam product. When utilizing such a mechanical fastener in a mold for production of an isocyanate-based polymer foam, specific care must be taken to avoid fouling of the touch fastening surface of the mechanical fastener with the liquid foamable composition which is dispensed into the mold. Fouling of the touch fastening surface can occur as a result of the liquid nature of the foamable composition, together with the generally above-ambient pressure conditions within the mold.

Thus, much attention in the prior art has been devoted to development of mechanical fasteners which are designed to obviate or mitigate fouling of the touch fastening surface by ingress of the liquid foamable composition. See, for example, any one of the following:
U.S. Pat. No. 4,470,857 [Casalou];
U.S. Pat. No. 4,563,380 [Black et al.];
U.S. Pat. No. 4,617,214 [Billarant];
U.S. Pat. No. 4,693,921 [Billarant];
U.S. Pat. No. 4,710,414 [Northrup et al.];
U.S. Pat. No. 4,726,975 [Hatch];
U.S. Pat. No. 4,784,890 [Black];
U.S. Pat. No. 4,802,939 [Billarant];
U.S. Pat. No. 4,814,036 [Hatch];
U.S. Pat. No. 4,842,916 [Ogawa et al.];
U.S. Pat. No. 4,933,035 [Billarant];
U.S. Pat. No. 5,171,395 [Gilcreast];
U.S. Pat. No. 5,688,576 [Ohno et al.];
U.S. Pat. No. 5,766,723 [Oborny et al.]; and
U.S. Pat. No. 5,972,465 [Ohno et al.].

As will be apparent to those of skill in the art, it is important to avoid fouling of the touch fastening surface by ingress of the liquid foamable composition to maximize mechanical adhesion between the two surfaces of the mechanical fastener. Even if this can be achieved, there are limitations to the prior art approach.

Specifically, while a number of advances in the art have served to reduce fouling of the touch fastening surface by ingress of the liquid foamable composition, other problems have arisen.

Specifically, it is conventional in the art to place the mechanical fastener in a mold with the operative touch fastening surface against the mold surface, typically in a trench in the mold surface for this purpose. It is also conventional to place a metal strip in the touch fastening surface together with a magnet disposed in the mold and appropriate placed to position the mechanical fastener in the mold during formation of the foam element.

As the foam element is produced, a build up of gas can occur in the trench of the mold in which the touch fastening surface is placed. This build up of gas occurs due to production of gas in the foaming mass and due to displacement of gas in the mold cavity which is replaced by expanding foam mass.

The occurrence of such gas formation in the trench and/or near the touch fastening surface leads to the production of sub-surface voids, end voids, trailing voids and the like in the vicinity of the mechanical fastener in the finished foam part. This results in poor adhesion of the mechanical fastener leading to de-lamination and tearing of the foam part.

Thus, there is an ongoing need in the art to solve the problem of sub-surface voids, end voids and/or trailing voids that occur when a mechanical fastener is molded into a foam part. It would be particularly advantages if a solution to these problems was relatively simple to implement and could be readily retrofitted to existing equipment to avoid significant increases in capital cost.

### SUMMARY OF THE INVENTION

It is an object of the present invention to obviate or mitigate at least one of the above-mentioned disadvantages of the prior art.

Accordingly, in one of its aspects, the present invention provides a method for production of a cushion element in a mold having a mold cavity, the mold comprising a first region for receiving a fastener assembly having a fastening surface, the method comprising the steps of:

(i) placing the fastener assembly in the mold such that at least a portion of the fastening surface contacts a first surface of the mold an interface;

(ii) dispensing a liquid foamable composition in the mold;

(iii) removing gas from the interface; and

(iv) expanding the liquid foamable composition to fill substantially the mold cavity to produce the cushion element.

In another of its aspects, the present invention provides a mold for production of a molded element, the mold comprising:

a first mold element and second mold element reversibly engageable to define a mold cavity;

at least one mechanical fastener receiving area disposed in at least one of the first mold element and the second mold element; and

a valve element in fluid communication with the at least one mechanical fastener receiving are, the valve element being actuated at a prescribed pressure to remove gas from the mechanical fastener receiving area.

Thus, the present inventor has determined that it is possible to regulate the build up of gas in or around the touch fastening surface of a mechanical fastener during production of a foam part in which the mechanical fastener is molded. More specifically, it is possible to utilize a valve element which is configured allow the release of gas from around the touch fastening surface when the pressure of such gas reaches a prescribed level.

The use of such a valve element in conjunction with a mechanical fastener, preferably in a trench of a mold adapted to receive a mechanical fastener, allows for mitigating or obviating the occurrence of sub-surface voids, end voids, trailing voids and the like in the resulting foam part. This leads to an increase in the de-lamination strength of the mechanical fastener in the foam part and to a reduction in the occurrence of tearing of the foam part.

Further, by using the appropriate operation parameter(s) for the valve element, it is possible to actually increase the de-lamination strength of the mechanical fastener in the foam element, particularly when using a mechanical fastener such as the one taught in the U.S. Pat. No. 5,766,723 [Oborny et al. (Oborny)]. The Obarny mechanical fastener has a peripheral co made of a foam element. The use of this mechanical fastener in the present invention is described in the more detail below.

The precise construction of the valve element is not particularly restricted provided it is capable of modulating the pressure around the touch fastening surface, preferably the pressure in a trench in the mold for receiving the mechanical fastener.

Practically, it is preferred that the operating parameter(s) of the valve element be from up to about 5 psi, more preferably in the range of from about 1 psi to about 5 psi, most prefereably from about 1.5 psi to about 4.0 psi. It is possible for the valve element to have an operating parameter as a single pressure in this range or multiple pressures in this range.

The optimum operating pressure for the valve element can be readily determined having regard to factors such as the density of the foam part, the amount of water (in direct blowing agent) used in the foam part and the like. It is within the purview of a person of ordinary skill in the art to determine (e.g., empirically) the appropriate operating pressure for the valve element.

Specifically, the operating pressure of the valve element should not be so low as to encourage foam intrusion into the touch fastening surface of the mechanical element. Further, the operating pressure of the valve element should not be too high as to encourage the creation of the above-mentioned voids.

The present inventor has implemented the invention using the valve elements having an operating or “cracking” pressure within the range of 1.5 psi to 4 psi. Useful such valve elements may be obtained by F. C. Kingston.

In one preferred embodiment, the valve element may be a needle valve. In another, more preferred embodiment, the valve element may be a spring loaded check valve having a “cracking pressure” within the operating pressure described above.

### BRIEF DESCRIPTION OF THE DRAWINGS

FIG. 1 is a perspective view of an embodiment in accordance with the present invention.

FIG. 2 is a partial cross-section of the FIG. 1 embodiment.

### DETAILED DESCRIPTION OF THE PRESENTLY PREFERRED EXEMPLARY EMBODIMENTS

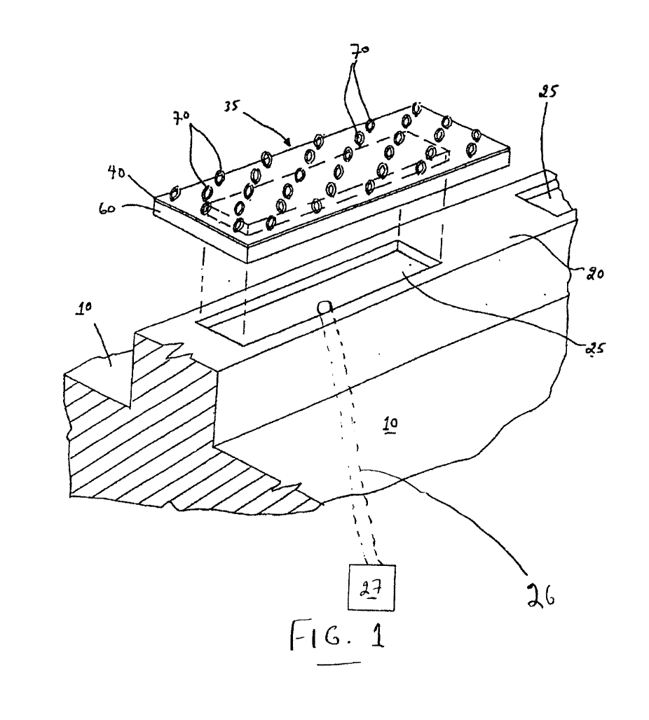

With reference to FIG. 1, there is illustrated a portion of a mold comprising a surface 10 in practise. Surface 10 would be a portion of a mold cavity, preferably such a mold cavity being formed by combination of a bowl (not shown) and a lid (not shown). The provision of such molds is conventional in the art.

Preferably, surface 10 is that of the bowl of the mold. In a preferred embodiment, this surface correspondence to the A-surface of the part to be produced.

As illustrated, disposed on surface 10 is a ridge 20. As will be appreciated by the those of skill in the art, ridge 20 serves to mold into the finished part a correspondingly shaped trench which is the relatively narrow, aesthetically appealing trench to be formed in the finished foam cushion element.

As shown, ridge 20 comprises a trench 25 disposed in the upper surface thereof.

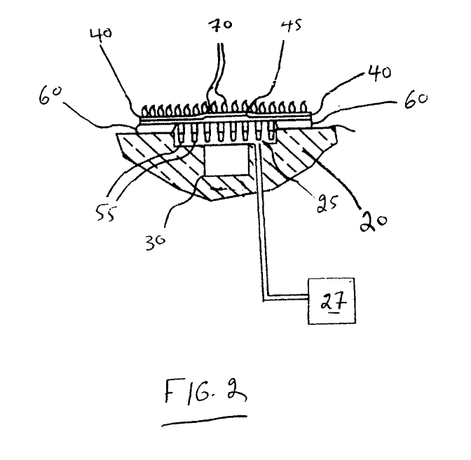

With reference to FIG. 2, ridge 20 further comprises a magnet 30 disposed in substantial alignment with trench 25.

Connected to trench 25 is a conduit 26 which is connected to a valve element 27 typically located below the bowl of the mold. Conduit 26 may be made of plastic tubing or the like and is connected to valve element 27 in a conventional manner.

An initial step of the present method involves placement of fastener assembly 35 on ridge 20. Thus, fastener assembly 35 comprises a backing layer 40 and a fastening layer 45 having a plurality of hook members 55. Hook members 55 are spaced radially from combined edges of backing layer 30 and fastening layer 45. Disposed in the margin defined by the spacing is a foam co element 60 of a similar type to that described in Obomy.

Sandwiched between backing layer 40 and fastening layer 45 is a magnetically attractable strip (not shown). Disposed on backing layer 40 a fastener assembly 35 are a number of loop members 70.

With continued reference to FIGS. 1 and 2, fasteners assembly 35 is placed on page 20 such that hook members 55 of fastener assembly 35 are disposed in trench 25. When fastener assembly 35 is disposed in the vicinity of trench 25, magnet 30 serves to attract the magnetically attractable strip (not shown) in fastener assembly 35. This attraction causes compression of a portion of foam seal element 60 disposed in the margins of fastener assembly 35.

Next, a liquid foamable composition, preferably an isocyanate-based polymer (e.g., polyurethane) foamable composition, is dispensed in the mold. As this composition expands, reaction gases are produced and gas contained in the mold cavity is displaced. A portion of these gases enters trench 25. Once the pressure within trench 25 reaches the operating pressure or “cracking pressure” of valve element 27 (discussed above), valve element 27 is actuated and gasses in trench 25 are released therefrom to an exterior of the mold cavity.

Thus, it will be appreciated if the gas pressure is allowed to build to too high a level, this will result in the creation of unwanted voids as discussed above. Further, the valve element 27 is actuated prematurely, this will encourage in grace of liquid foam into trench 25 thereby fouling hook members 55.

Thus, it is possible, as discussed above, to select the operating pressure or “cracking pressure” of valve element 27 to result in partial impregnation of liquid foam into to foam seal element 60 of fastener assembly 35. This results in production of densified seal around trench 25 with the result that the de-lamination strength of fastener assembly 35 is actually improved. This leads the potential to use narrower versions of fastener assembly 35 to achieve a prescribed de-lamination strength thereby resulting in finished parts having narrower, more aesthetically pleasing trenches.

While the illustrate embodiments shows a single valve element 27 for a single trench in a single trench, it is, of course, possible to use a single valve element 27 for multiple trenches and/or multiple ridges. In fact, there is the potential to use a single valve element to moderate the build up of gas pressure in all trenches in a given mold.

While this invention has been described with reference to illustrative embodiments and examples, the description is not intended to be construed in a limiting sense. Thus, various modifications of the illustrative embodiments, as well as other embodiments of the invention, will be apparent to persons skilled in the art upon reference to this description. It is therefore contemplated that the appended claims will cover any such modifications or embodiments.

All publications, patents and patent applications referred to herein are incorporated by reference in their entirety to the same extent as if each individual publication, patent or patent application was specifically and individually indicated to be incorporated by reference in its entirety.

1. A method for production of a cushion element in a mold having a mold cavity, the mold comprising a first region for receiving a fastener assembly having a fastening surface, the method comprising the steps of:
(i) placing the fastener assembly in the mold such that at least a portion of the fastening surface contacts a first surface of the mold an interface;
(ii) dispensing a liquid foamable composition in the mold;
(iii) removing gas from the interface; and
(iv) expanding the liquid foamable composition to fill substantially the mold cavity to produce the cushion element.

2. The method defined in claim 1, wherein Step (iii) comprises removing gas from the interface after gas pressure at the interface reaches a predetermined value.

3. The method defined in claim 1, wherein Step (iii) comprises removing gas from the interface after gas pressure at the interface is a value up to about 5 psi.

4. The method defined in claim 1, wherein Step (iii) comprises removing gas from the interface after gas pressure at the interface is a value in the range of from about 1 psi about 5 psi.

5. The method defined in claim 1, wherein Step (iii) comprises removing gas from the interface after gas pressure at the interface is a value in the range of from about 1.5 psi about 4 psi.

6. The method defined in claim 1, wherein Step (iii) comprises removing gas from the interface after gas pressure at the interface is about 2.5 psi.

7. The method defined in claim 6, wherein the interface comprises a trench portion in the mold for receiving at least a portion of the fastening surface.

8. The method defined in claim 7, wherein Step (iii) comprises removing gas from the trench portion.

9. The method defined in claim 8, wherein the fastener assembly further comprises a resilient element in a marginal portion thereof.

10. The method defined in claim 8, wherein the fastener assembly further comprises a resilient element in a peripheral portion thereof such that the fastening surface is disposed in a central region of the fastener assembly.

11. The method defined in claim 10, wherein the resilient element comprising a foam element.

12. The method defined in claim 11, wherein the foam element has an Indentation Force Deflection, when measured pursuant to ASTM D3574-95 in the range of from about 10 to about 1000 pounds·force.

13. The method defined in claim 11, wherein the foam element has an Indentation Force Deflection in the range of from about 10 to about 500 pounds·force.

14. The method defined in claim 11, wherein the foam element has an Indentation Force Deflection in the range of from about 10 to about 250 pounds·force.

15. The method defined in claim 11, wherein the foam element has an Indentation Force Deflection in the range of from about 30 to about 100 pounds·force.

16. The method defined in claim 15, wherein the foam element comprises a polyurethane foam.

17. The method defined in claim 16, comprising the further step of:
(v) partially impregnating the resilient element with the liquid foamable composition

18. The method defined in claims 17, wherein the mold comprises a bowl and a lid engageable to define the mold cavity, and Step (i) comprises placing the fastener assembly in the bowl.

19. The method defined in claim 18, wherein the bowl and the lid are disengaged during Step (ii).

20. The method defined in claim 19, wherein the bowl and the lid are engaged after Step (ii).

21. The method defined in claim 20, wherein the mold comprises a magnet disposed adjacent the interface and Step (i) further comprises magnetically securing the fastener assembly with respect to the trench.

22. The method defined in claim 21, wherein Step (i) comprises placing the fastener assembly on a raised platform disposed in the mold cavity.

23. A mold for production of a molded element, the mold comprising:
a first mold element and second mold element reversibly engageable to define a mold cavity;
at least one mechanical fastener receiving area disposed in at least one of the first mold element and the second mold element; and
a valve element in fluid communication with the at least one mechanical fastener receiving are, the valve element being actuated at a prescribed pressure to remove gas from the mechanical fastener receiving area.

24. The mold defined in claim 23, wherein the at least one mechanical fastener receiving area comprises a trench portion for receiving a fastening surface of a mechanical fastener.

25. The mold defined in claim 24, wherein the valve element is actuated at a gas pressure of up to about 5 psi.

26. The mold defined in claim 24, wherein the valve element is actuated at a gas pressure in the range of from about 1 psi about 5 psi.

27. The mold defined in claim 24, wherein the valve element is actuated at a gas pressure in the range of from about 1.5 psi about 4 psi.

28. The mold defined in claim 24, wherein the valve element is actuated at a gas pressure of about 2.5 psi.

29. The mold defined in claim 28, comprising a plurality of mechanical fastener receiving areas.

30. The mold defined in claim 29, further comprising a raised platform in which is disposed the at least one mechanical fastener receiving area.

31. The mold defined in claim 29, further comprising a raised platform in which is disposed one mechanical fastener receiving area.

32. The mold defined in claim 29, further comprising a raised platform in which is disposed a plurality of mechanical fastener receiving areas.

33. The mold defined in claim 29, wherein a single valve element is provided for each mechanical fastener receiving area.

34. The mold defined in claim 29, wherein a single valve element is provided for a plurality of mechanical fastener receiving areas.
